(19) United States
(12) Patent Application Publication
(10) Pub. No.: US 2015/0046727 A1
(43) Pub. Date: Feb. 12, 2015

(54) FEEDING METHOD AND ELECTRONIC APPARATUS

(71) Applicant: Kabushiki Kaisha Toshiba, Tokyo (JP)

(72) Inventor: Hiroki KOBAYASHI, Tokyo (JP)

(21) Appl. No.: 14/456,906

(22) Filed: Aug. 11, 2014

Related U.S. Application Data
(60) Provisional application No. 61/864,973, filed on Aug. 12, 2013.

(51) Int. Cl. G06F 1/26

(52) U.S. Cl. CPC G06F 1/266
USPC 713/300

(57) ABSTRACT

In a method for supplying electric power to a USB device connected to a general-purpose USB port in an electronic apparatus, the method comprising: determining whether the USB device is connected; acquiring electric power required by the USB device; setting an overcurrent threshold value based on the required electric power; and supplying electric power to the USB device within the overcurrent threshold value.

### FIELD

An embodiment of the present invention relates to a feeding method and an electronic apparatus.

### BACKGROUND

Since standards of USB (Universal Serial Bus) Power Delivery (hereinafter called UPD) are defined, for example, a large amount of electric power can be supplied from a USB connector of a PC (Personal Computer), and an external monitor for PC can be driven by only electric power supplied from the USB connector. In the future, an idea of supplying a large amount of electric power from a PC body through the USB connector is required in the case of designing a UPD-capable PC.

A problem is that when electric power is supplied from a USB port of a PC to the outside, the electric power of more than or equal to an adapter rating for AC driving or a battery rating capacity for battery driving cannot be normally supplied to the outside. Also, in the case of solving this problem and making an idea capable of supplying the electric power of more than or equal to the adapter rating or the battery rating capacity under certain conditions, a method of overcurrent protection mounted in a general USB port requires measures since even when a condition for increasing electric power capable of supply is not satisfied, a large current can be drawn from the USB port and this may become a cause of trouble of the PC body and a connected adapter.

Though there is also an idea of providing notification of information as to whether or not a connected device can operate according to a state of a power source connected to the PC, notification of the amount of electric power supply available according to a load status is further desired. However, means for achieving such a desire is not known.

### BRIEF DESCRIPTION OF THE DRAWINGS

FIG. 1 is a perspective view showing an external appearance of an electronic apparatus according to an embodiment.

FIG. 2 is a block diagram showing a system configuration of the electronic apparatus according to the same embodiment.

FIG. 3 is a characteristic system configuration diagram shown in order to describe an effect of the same embodiment.

FIG. 4 is a block configuration diagram showing a protection circuit mechanism of a USB port of a notebook PC of another example of a part of the same embodiment.

FIG. 5 is a processing flowchart of a characteristic diagram showing a monitor gamma characteristic curve used in the same embodiment.

FIGS. 6A, 6B and 6C are block configuration diagrams showing a method for mounting an overcurrent protection circuit of the same embodiment.

FIGS. 7A and 7B are diagrams describing an IIC interface used in the embodiment.

FIG. 8 is an outline diagram of Architecture of a set of Consumer and Provider of UPD.

### DETAILED DESCRIPTION

According to one embodiment, a method for supplying electric power to a USB device connected to a general-purpose USB port in an electronic apparatus, the method comprising: determining whether the USB device is connected; acquiring electric power required by the USB device; setting an overcurrent threshold value based on the required electric power; and supplying electric power to the USB device within the overcurrent threshold value.

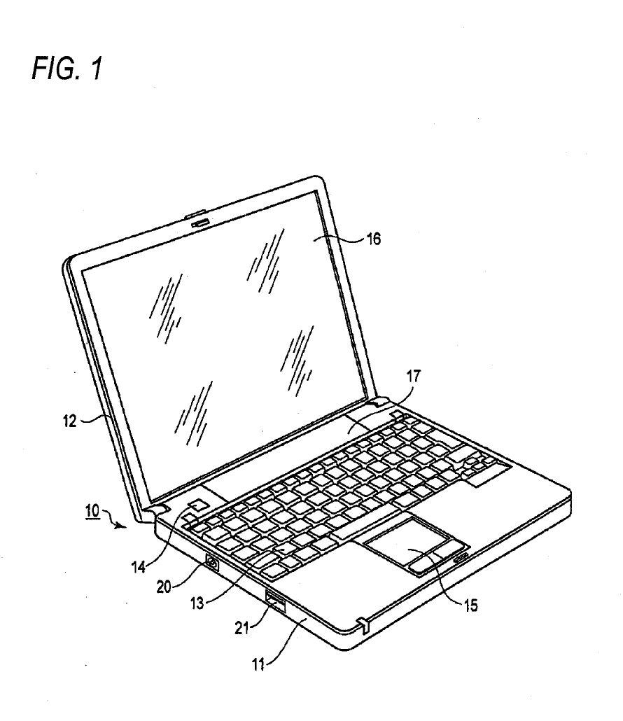

Various embodiments will be described hereinafter with reference to the accompanying drawings FIGS. 1 to 8.

First, a configuration of an electronic apparatus according to one embodiment will be described with reference to FIG. 1. This electronic apparatus is configured to receive electric power from a battery. This electronic apparatus can be implemented as, for example, a notebook portable personal computer, a tablet terminal or various other information processors. Hereinafter, the case of implementing this electronic apparatus as a notebook portable personal computer 10 is assumed.

FIG. 1 is a perspective view seeing the computer 10 with a display unit opened from the front side. The present computer 10 is configured to receive electric power from a battery 17. The battery may be constructed of a normal lithium-ion battery etc. with the intention of increasing capacity.

The computer 10 uses electric power discharged from the battery 17 in order to supply electric power to a component of the inside of the computer 10. A power source output terminal of the battery 17 may make wired OR connection to a power source output terminal of an external power source device such as an AC adapter. In this case, an output voltage of the battery 17 may be set so that an output voltage of an external power source becomes higher than the output voltage of the battery 17. Accordingly, electric power can be supplied to the component of the inside of the computer 10 using electric power from the external power source device preferentially than the battery 17.

Further, a charging circuit of the inside of the computer 10 charges the battery 17 using electric power from the external power source device when the battery 17 is not in a full charge state.

The computer 10 includes a computer body 11 and a display unit 12. A display device constructed of an LCD 16 (Liquid Crystal Display) is incorporated into the display unit 12.

The display unit 12 is attached to the computer body 11 turnably between an opened position in which an upper surface of the computer body 11 is exposed and a closed position in which the upper surface of the computer body 11 is covered with the display unit 12. The computer body 11 has a cabinet with a thin box shape, and a keyboard 13, a power source switch 14 for powering on and off the computer 10 and a touch pad 15 are arranged on an upper surface of the cabinet.

Also, the computer body 11 is provided with a power source connector 20. The power source connector 20 is formed on a side surface, for example, a left side surface of the computer body 11. The external power source device is detachably connected to this power source connector 20. As the external power source device, the AC adapter can be used as described above. The AC adapter is a power source device for converting a commercial power source (AC electric power) into DC electric power.

The power source connector 20 is constructed of a jack to which a power source plug derived from the external power source device such as the AC adapter can be detachably connected. The battery 17 is detachably attached to, for example, the back end of the computer body 11. The battery 17 may be a battery built into the computer 10.

The computer 10 is driven by electric power from the external power source device or electric power from the battery 17. When the external power source device is connected to the power source connector 20 of the computer 10, the computer 10 is driven by the electric power from the external power source device. When electric power consumed by the computer 10 greatly increases for some reason, the amount of electric power required by the computer 10 may exceed the amount of electric power supplied from the external power source device. In this case, electric power from the battery 17 as well as electric power from the external power source device is used. One operation which becomes a factor in increasing the electric power consumed by the computer 10 includes operation of charging a portable device attached to the computer 10.

Also, as described above, the electric power from the external power source device is used for charging the battery 17. During a period during which the computer 10 is powered off as well as during a period during which the computer 10 is powered on, the battery 17 may be charged. During a period during which the external power source device is not connected to the power source connector 20 of the computer 10, the computer 10 is driven by the electric power from the battery 17.

Further, the computer body 11 is provided with a port (connector) 21 such as a USB port. This port 21 is a port used for detachably attaching a portable device to the computer body 11. This port 21 is used for communication between the computer 10 and the portable device. Further, this port 21 can be used for charging the portable device or supplying electric power to the portable device. Hereinafter, the case where this port 21 is a universal serial bus (USB) port is assumed.

In the USB port, generally, a pair of power source lines (VBUS, ground (GND)), a positive data line (D+) and a negative data line (D−) are defined. The VBUS is a positive power source line. The computer 10 can supply electric power (bus power) to the portable device attached to the USB port 21 through the VBUS and the ground (GND).

The positive data line (D+) and the negative data line (D−) function as a differential signal line pair. The computer 10 can communicate with the portable device attached to the USB port 21 through the positive data line (D+) and the negative data line (D−).

The computer 10 has a charger function capable of charging a battery of the portable device. The conventional charger function has two charging modes, that is, a normal mode and a large-current charging mode. The normal mode is a charging mode capable of supplying a current (first charging current) of, for example, a maximum of 0.5 A to the portable device. The large-current charging mode is a charging mode capable of supplying a current (second charging current) of, for example, a maximum of 1.5 A larger than that of the normal mode to the portable device. For a period during which the computer 10 is in a power-on state, the charger function can charge the battery of the inside of the portable device using any charging mode of the two charging modes, that is, the normal mode and the large-current charging mode. In other words, for a period during which the computer 10 is in the power-on state, the USB port 21 can function as either a first type port capable of supplying the first charging current or a second type port capable of supplying the second charging current larger than the first charging current.

The first type port may correspond to a standard downstream port (SDP) defined by, for example, Battery Charging Specification Revision 1.1. Also, the second type port may correspond to a charging downstream port (CDP) defined by Battery Charging Specification Revision 1.1.

The battery of the portable device can be charged at high speed by using the second type port (large-current charging mode).

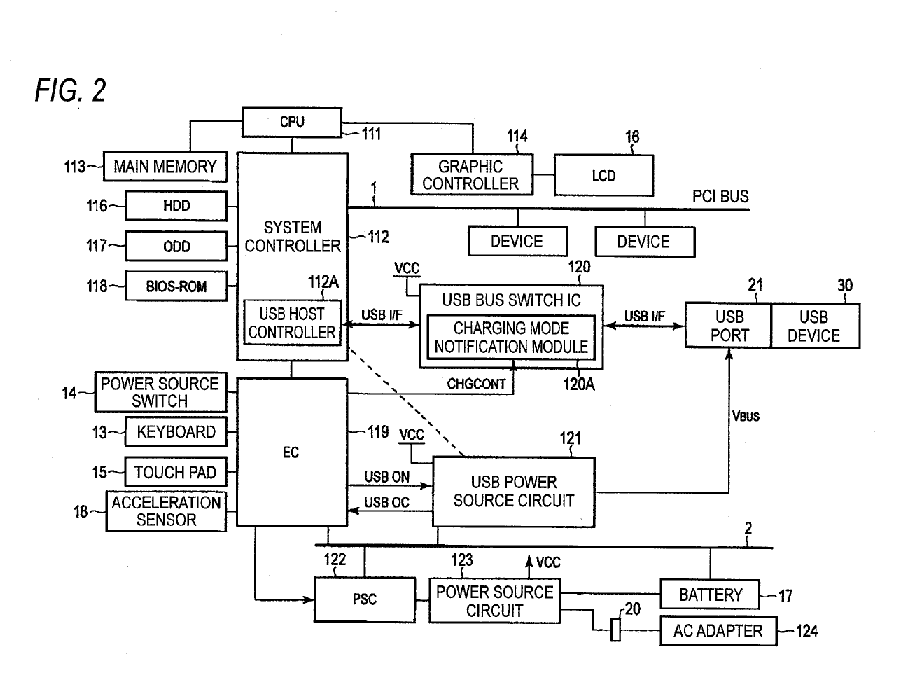

FIG. 2 shows a system configuration of the computer 10. The computer 10 includes a CPU 111, a system controller 112, a main memory 113, a graphics controller 114, a hard disk drive (HDD) 116, an optical disk drive (ODD) 117, a BIOS-ROM 118, an embedded controller (EC(/KBC)) 119, a USB bus switch IC 120, a USB power source circuit 121, a power source controller (PSC) 122, a power source circuit 123, etc.

The CPU 111 is a processor for controlling operation of each component of the computer 10. This CPU 111 executes various software, for example, an operating system (OS) and various application programs loaded from the HDD 116 to the main memory 113. Also, the CPU 111 executes a basic input/output system (BIOS 118a) stored in the BIOS-ROM 118 which is a nonvolatile memory. The BIOS 118a is a system program for hardware control

The system controller 112 is a bridge device for making connection between the CPU 111 and each component. The CPU 111 has a function of communicating with the graphics controller 114. Further, a memory controller for controlling the main memory 113 is built into the CPU 111. The graphics controller 114 is a display controller for controlling the LCD 16 used as a display monitor of the computer 10.

The system controller 112 is connected to a PCI bus (exactly, this succeeding PCI Express Bus) 1, and communicates with each device on this bus. Also, a Serial ATA controller or an IDE (Integrated Drive Electronics) controller for controlling the hard disk drive (HDD) 116 and the optical disk drive (ODD) 117 is built into the system controller 112.

Further, the system controller 112 includes a USB host controller 112A. The USB host controller 112A is a host controller constructed so as to control a USB device 30 which is a portable device detachably attached to the USB port 21, and communicates with the USB device 30. Communication between the USB host controller 112A and the USB device 30 is conducted through a USB interface (USBI/F). The USB interface includes the positive data line (D+) and the negative data line (D−) described above.

In the embodiment, the USB host controller 112A is connected to the USB port 21 through the USB bus switch IC 120. The USB bus switch IC 120 includes a charging mode notification module 120A in order to instruct the USB device 30 on a charging mode (USB charging mode) supported by the computer 10.

The charging mode notification module 120A executes operation of notifying the USB device 30 whether the present USB charging mode of the computer 10 is the normal mode or the large-current charging mode, that is, the USB port 21 is the first type port (for example, the standard downstream port (SDP)) or the second type port (for example, the charging downstream port (CDP)) by communication with the USB device 30 through the USB port 21.

For example, the USB device 30 can execute processing (charger detection processing) for detecting a type of the USB port 21 according to a protocol defined by Battery Charging Specification Revision 1.1. The charging mode notification module 120A has a function of responding to the charger detection processing executed by the USB device 30.

The charger detection processing is started by the USB device 30 in order to determine the type of the USB port 21 of the computer 10 (host device). That is, the USB device 30 attached to the USB port 21 determines the type of the USB port 21 by applying a predetermined voltage to the positive data line (D+) and checking a voltage on the negative data line (D−).

The charging mode notification module 120A executes either response processing for notification that the USB port 21 is the first type port or response processing for notification that the USB port 21 is the second type port according to a charging mode setting signal (CHGCONT) from the EC 119.

The USB power source circuit 121 operates as a first power source circuit constructed so as to supply bus power (V_{BUS}) to the USB device 30 through the USB port 21. The USB power source circuit 121 is designed to have electric power supply capability capable of charging a large current like the charging downstream port (CDP). The USB power source circuit 121 is turned on or off according to a USBON signal from the EC 119.

Also, the USB power source circuit 121 has an overcurrent detection function, and detects whether or not a current drawn by the USB device 30 through the USB port 21 exceeds an upper limit value. In the case of detecting that the current drawn by the USB device 30 exceeds the upper limit value, the USB power source circuit 121 generates a USB overcurrent detection signal USBOC and notifies the EC 119 that an overcurrent is detected. In this case, the EC 119 may turn off the USB power source circuit 121.

The EC 119, the power source controller (PSC) 122 and the battery 17 are interconnected through a serial bus 2 such as an I²C bus. The embedded controller (EC) 119 is a power source management controller for managing electric power of the computer 10, and is implemented as, for example, a one-chip microcomputer incorporating a keyboard controller for controlling the keyboard (KB) 13, the touch pad 15, etc. The EC 119 has a function of powering on and off the computer 10 according to a manipulation of the power source switch 14 by a user. Control of power-on and power-off of the computer 10 is performed by cooperation with the EC 119 and the power source controller (PSC) 122. When an ON signal sent from the EC 119 is received, the power source controller (PSC) 122 controls the power source circuit 123 and powers on the computer 10. Also, when an OFF signal sent from the EC 119 is received, the power source controller (PSC) 122 controls the power source circuit 123 and powers off the computer 10. Also during a period during which the computer 10 is powered off, the EC 119, the power source controller (PSC) 122 and the power source circuit 123 operate by electric power from the battery 17 or the AC adapter 124.

Further, the EC 119 monitors the remaining capacity of the battery 17, and when the remaining capacity of the battery 17 is smaller than a threshold value, operation of the USB bus switch IC 120 (the charging mode notification module 120A) is controlled so that the USB port 21 is recognized as the first type port by the USB device 30. The EC 119 can receive, for example, battery information indicating the remaining capacity of the battery 17 from the power source controller (PSC) 122. Of course, the EC 119 may directly receive the battery information indicating the remaining capacity of the battery 17 from the battery 17. Further, the EC 119 performs control of the USB power source circuit 121.

Also, the computer body 11 is provided with an acceleration sensor 18. This acceleration sensor 18 is formed, for example, inside the computer body 11. For example, this acceleration sensor 18 is connected to the EC 119 in addition to the configuration described above.

The acceleration sensor 18 is an acceleration sensor etc. in three axis directions (X, Y, Z directions) or six axis directions adding detection of a rotational direction around each axis to the three axis directions, and detects the direction and magnitude of acceleration from the outside with respect to the computer body 11, and outputs the direction and magnitude to the CPU 111 through the EC 119. Concretely, the acceleration sensor 18 outputs an acceleration detection signal (inclination information) including the axis, the direction (rotational angle for rotation) and the magnitude, in which acceleration is detected, to the CPU 111. In addition, a form in which a gyro sensor for detection of angular velocity (rotational angle) is integrated into the acceleration sensor 18 may be used.

The embedded controller (EC) 119, the USB bus switch IC 120 and the USB power source circuit 121 function as a charging control device constructed so as to control charging of the USB device 30 attached to the USB port 21.

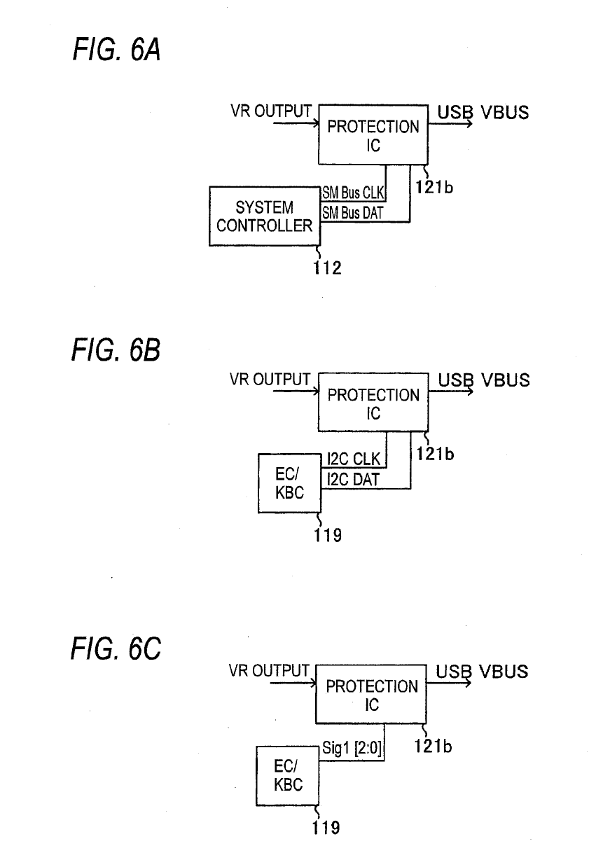

Also during a period during which the computer 10 is powered off, the charging control device can charge the USB device 30. In this case, the USB device 30 may be charged, for example, using the normal mode described above. In addition, coupling shown by a broken line between the system controller 112 and the USB power source circuit 121 represents bus coupling of a signal line of Sig1[2:0] or SM Bus I/F described below in FIGS. 6A to 6C.

The power source circuit 123 generates electric power (an operating power source) to be supplied to each component using electric power from the battery 17 or electric power from an AC adapter 124 connected to the computer body 11 as an external power source. When the AC adapter 124 is connected to the computer body 11, the power source circuit 123 generates the operating power source to each component using the electric power from the AC adapter 124, and also charges the battery 17.

Now in the embodiment, in order to cope with a UPD-capable device for requiring larger electric power supply while maintaining compatibility with the above, when both of the AC adapter and the battery are connected to a PC, electric powers of the battery as well as the AC are simultaneously used in an outside output to increase the amount of electric power capable of being outputted from the USB port of the PC. Since the amount of electric power capable of being supplied to the outside always changes by an adapter rating, a battery capacity and system power consumption, the computer body 11 notifies the connected UPD-capable USB device 30 of the amount of electric power changing.

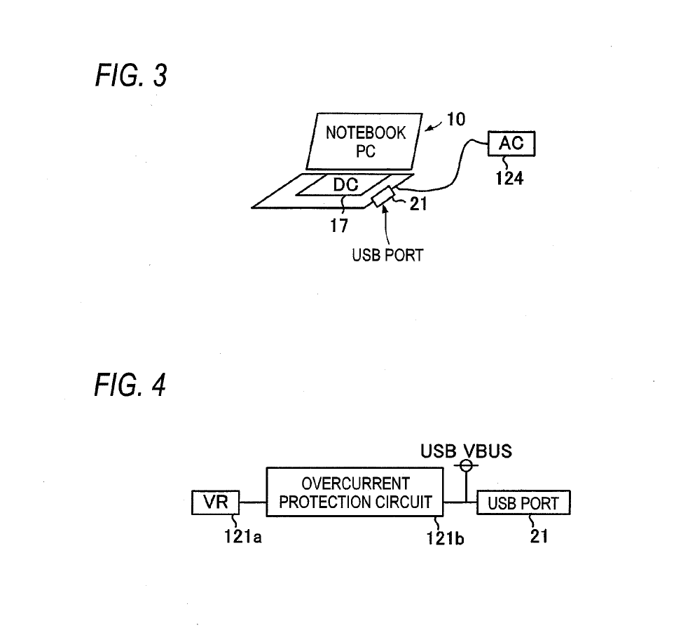

As shown in a simplified system configuration diagram of FIG. 3, a target notebook PC (computer 10) includes the AC adapter 124, the battery 17 (DC), and the USB port 21 to which the UPD-capable USB device 30 can be connected. Also, this notebook PC includes a presently connected AC adapter rating capacity storage module and a capacity detection module (not shown) for acquiring a battery capacity. Further, the PC includes an electric power detection module (not shown) for acquiring power consumption of the whole system.

Also, as shown in a circuit configuration about the USB port 21 of the notebook PC of FIG. 4, the PC has an overcurrent protection circuit 121b capable of setting a threshold value of a current in the case of providing overcurrent protection of a USB VBUS (V_{BUS}) line in multiple stages. This protection circuit is a circuit for breaking electric power supply when a current exceeding the set threshold value Id(A) of the current flows. The overcurrent protection circuit 121b breaks electric power supply from a Voltage Regulator 121a (VR) inside the USB power source circuit 121.

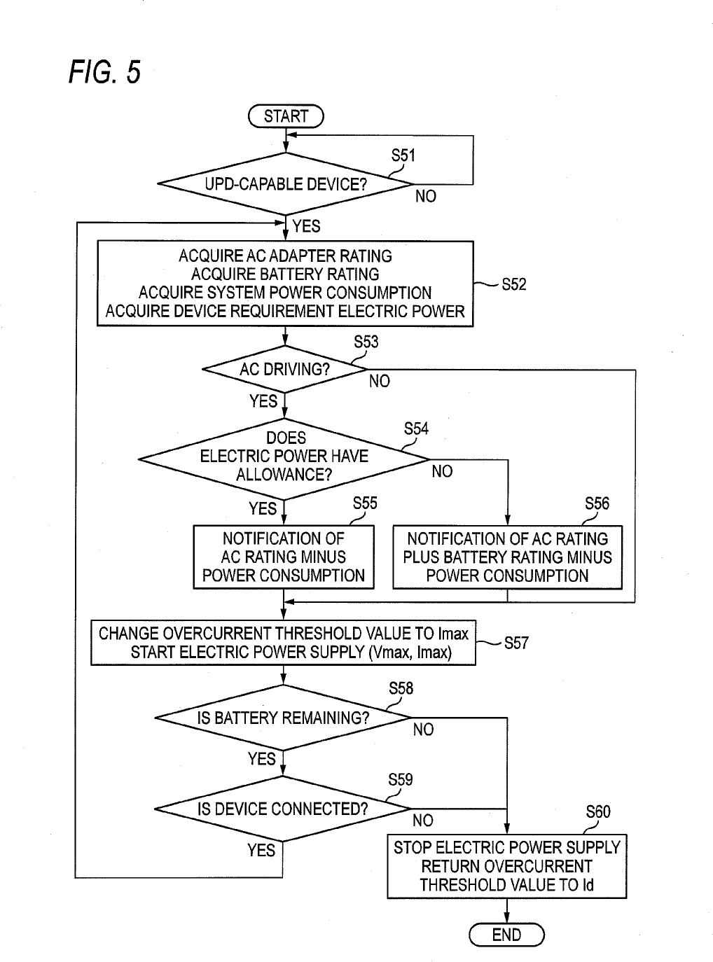

FIG. 5 is a processing flowchart based on the CPU 111. As shown in this processing flowchart, briefly, when the UPD-capable USB device 30 is connected to the computer 10, the computer 10 first acquires and stores the maximum power consumption of its device. The computer 10 acquires the maximum power consumption via a USB using a UPD protocol described below. Subsequently, the computer 10 detects a state of a power source connected to the system. The computer 10 acquires a rating capacity of the AC adapter 124 when the AC adapter 124 is connected, and acquires a rating capacity and the remaining capacity of the battery 17 when the battery 17 is also connected, and further acquires power consumption of the whole system.

Step S51: The CPU 111 detects connection of a UPD-capable USB device through the system controller 112, and continues idling until its detection.

Step S52: The computer 10 acquires four pieces of information (an AC adapter rating, a battery rating, system power consumption and device requirement electric power) about operation of the UPD-capable USB device 30 detected.

Step S53: The computer 10 determines whether or not AC driving is used, and proceeds to step S54 when the AC driving is used, and proceeds to step S57 when the AC driving is not used. That is, the processing branches according to a state of a power source connected to a notebook PC. When a system in this processing flow is driven by only a battery, the connected device is notified of a difference between the rating capacity of the battery and the power consumption of the whole system as the amount of electric power capable of supply.

Step S54: The computer 10 determines whether or not electric power has an allowance, and proceeds to step S56 when the electric power does not have the allowance. This allowance is determined by a state as to whether or not an AC rating minus power consumption is larger than the device requirement electric power.

Step S55: The computer 10 notifies the USB device 30 of a value of the AC adapter rating minus the power consumption, and proceeds to step S57. A UPD protocol (Protocol layer) described below is used in notification of the amount of electric power. For example, when the adapter rating is 60 W and the system power consumption is 20 W, 40 W is obtained as an available electric power value of which the device is notified. When the system is driven by the AC and the battery, a difference between the adapter rating capacity and the power consumption of the whole system acquired is compared with the amount of electric power required by the connected device, and when the requirement electric power is smaller, the device is notified of the adapter rating capacity minus the power consumption. For example, when the device requirement electric power is 20 W and the adapter rating is 60 W and the system power consumption is 20 W, only an adapter output enables supply to the device, with the result that the device is notified of 40 W.

Step S56: The computer 10 provides notification of a value of the AC rating plus the battery rating minus the power consumption, and proceeds to step S57. On the other hand, when the requirement electric power is larger, the device is notified of a difference between the system power consumption and the addition of the battery rating capacity to the adapter rating capacity. For example, when the adapter rating is 60 W and the system power consumption is 40 W and the battery rating is 60 W, 80 W is obtained as available electric power of which the device is notified.

Step S57: The computer 10 changes an overcurrent threshold value to Imax. Also, the computer 10 starts electric power supply at Vmax and Imax. Here, after the start of electric power supply to the UPD device 30, a threshold value of a current value of the overcurrent protection circuit 121b is changed to the maximum current value supplied to the device. When electric power required by the UPD device 30 falls below electric power which the notebook PC can output, authentication of the device is completed in conformity with UPD standards, and electric power supply to the UPD device 30 is started from the notebook PC.

Step S58: The EC 119 determines whether or not the battery 17 is remaining (N % or more, for example, N=5) using the PSC 122, and proceeds to step S60 when the battery is not remaining. Also after the authentication of the device, this flow is executed periodically and the current value set by the overcurrent protection circuit 121b is also updated every time.

Step S59: The computer 10 determines whether or not the UPD device is connected, and returns to step S51 when the UPD device is connected, and proceeds to step S60 when the UPD device is not connected.

Step S60: The computer 10 stops the electric power supply, and also returns the overcurrent threshold value to Id(A), and ends the processing. Also, when the battery capacity decreases to N% or less in the processing flow step S58 or S59 as described above, or when the system power consumption increases and electric power required by the connected device cannot be supplied, the electric power supply to the device is stopped and the threshold value of the current value of the overcurrent protection circuit 121b is reset at Id(A) of a default.

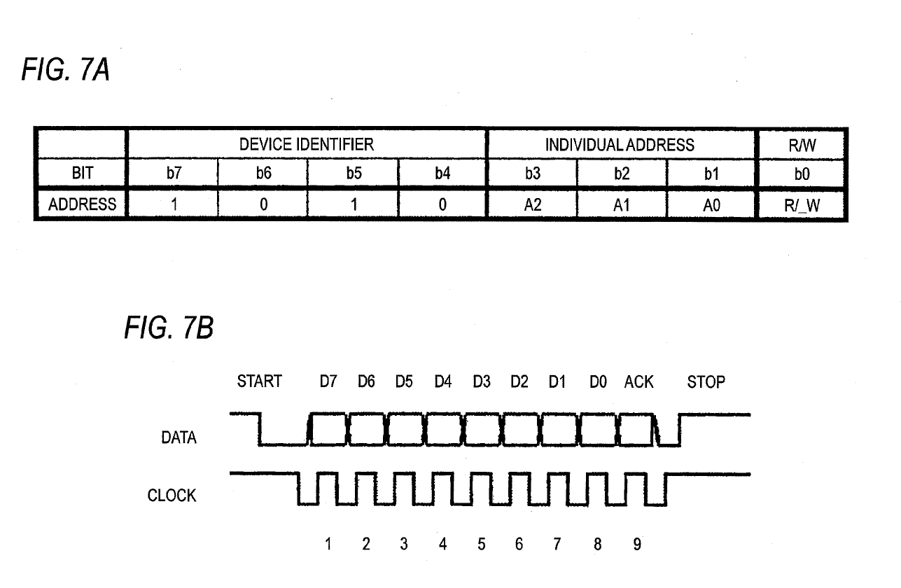

In addition, as shown in FIGS. 6A to 6C, a method for changing the threshold value of the current value set by the overcurrent protection circuit 121b changes a threshold value of a protection IC which is the overcurrent protection circuit 121b through an SM Bus I/F (FIG. 6A) of an external controller or an I²C I/F (FIG. 6B) or two or three signal lines (FIG. 6C). In the case of FIG. 6B, transfer is performed as shown in the contents of communication of description of next FIG. 7 and information for setting the current threshold value in multiple stages is provided. Also, in the case of FIG. 6C, multiple-stage setting information is provided by using plural lines of, for example, several tens of GPIO (General Purpose Input/Output) as a signal line of Sig1[2:0].

FIGS. 7A and 7B are diagrams describing the IIC (the above I²C) interface. A bus (IIC-BUS) of the IIC interface includes two communication lines of a pull-up clock outputted from a master device and data for conducting two-way communication between the master device and a slave device.

FIG. 7A shows a configuration example of a slave address. The slave address has an 8-bit length, and the four high bits are fixed according to a kind of device. Also, the one low bit represents writing for 0 and reading for 1. Consequently, bits 1 to 3 can actually be used in the slave address.

FIG. 7B is an outline diagram of timing of two lines, and as shown in the upper side, a level value of a signal of a data line becomes LOW to thereby become Start, and data is sequentially sent from the high bit, and the level value of the signal of the data line becomes HIGH to thereby become Stop. Timing of a corresponding clock line is shown in the lower side. FIG. 7B is an example of transfer of one byte, and by repeating data and ACK by the Stop state plural times, the first byte is the slave address and the remaining bytes can have the contents of communication.

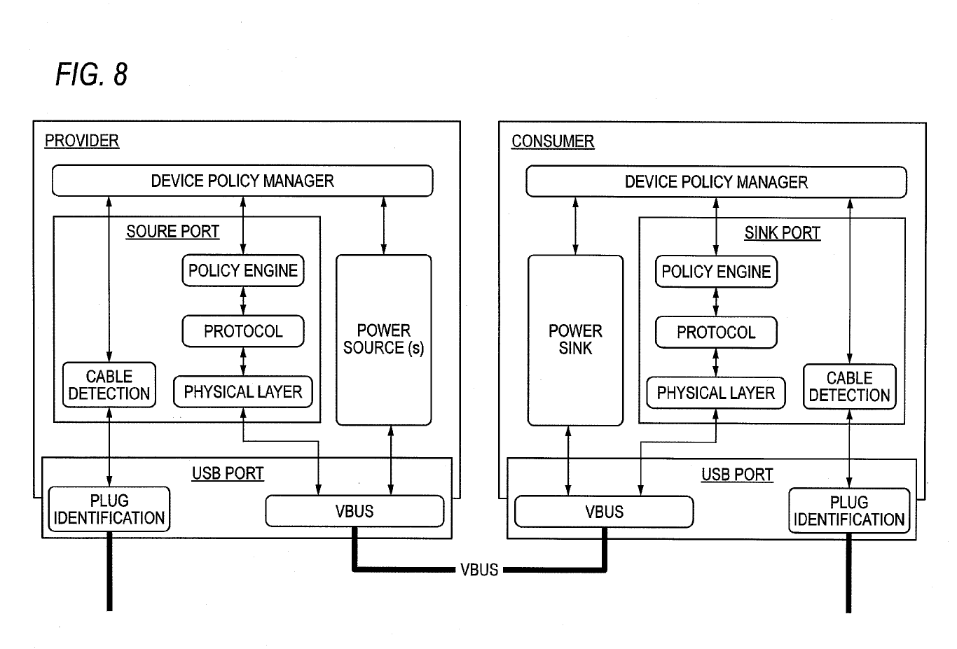

FIG. 8 is an outline diagram of Architecture of a set of Consumer and Provider of UPD.

In a Protocol layer in this diagram, a method for constructing and using Message becomes a key. Message includes a header and a variable-length data part (including 0), and the following two types of Message are defined.

Control Message has a 16-bit length, and values of field Bits 14-12 are 0. On the other hand, in Data Message, a header similarly has a 16-bit length, but values (Number of Data Objects) of Bits 14-12 represent the number of data of a 32-bit unit in a subsequent data part.

The data part of Data Message includes plural types of Data Object defined by values of field Bits 3-0 of the header.

(1) Power Data Object (PDO) used for showing necessary electric power of Sink or power capability of Source Port

(2) Request Data Object (RDO) used by Sink Port in order to negotiate power contract

In addition, in Physical Layer, this power contract is negotiated by V_{bus} rather than a data line.

The mechanism of overcurrent protection in the case of increasing an external output current using the battery has been described above. Though there is a limit to the operating time, the device requiring electric power in which the AC adapter exceeds supply capability can temporarily be connected to the USB port of the PC to be operated. Also, by changing a protection current value, a cause of trouble of the PC body or the connected AC adapter can be decreased even when the value of the current flowing through the USB port of the PC body increases temporarily.

Through the USB port, the connected device is dynamically notified of the amount of supply of electric power capable of being supplied to the outside always varying according to a load status of the system, the battery capacity and the AC adapter rating connected to the system. Also, according to the amount of electric power capable of being supplied, of which the system notifies the device, the threshold value of the current value on which overcurrent protection operates is dynamically changed to protect the system.

In addition, this invention is not limited to the embodiment described above and moreover, various modifications can be made without departing from the gist of the invention.

Also, various inventions can be formed by properly combining plural components disclosed in the embodiment described above. For example, several components may be eliminated from all the components shown in the embodiment. Further, components related to different embodiments may be combined properly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for supplying electric power to a USB device connected to a general-purpose USB port in an electronic apparatus, comprising:
determining whether the USB device is connected;
acquiring electric power required by the USB device;
setting an overcurrent threshold value based on the required electric power; and
supplying electric power to the USB device within the overcurrent threshold value.

2. The method of claim 1,
wherein the overcurrent threshold value is set based on USB Power Delivery standards.

3. The method of claim 2,
wherein the overcurrent threshold value is set using SM Bus.

4. The method of in claim 2,
wherein the overcurrent threshold value is set using I²C.

5. The method of claim 2,
wherein the overcurrent threshold value is set using General Purpose Input/Output (GPIO).

6. An apparatus for supplying electric power to a USB device connected to a general-purpose USB port, comprising:
a determining controller configured to determine whether the USB device is connected;
a acquiring controller configured to acquire electric power required by the USB device;
a setting controller configured to set an overcurrent threshold value based on the required electric power; and
a supplying controller configured to supply electric power to the USB device within the overcurrent threshold value.
